(19) United States
(12) Patent Application Publication
(10) Pub. No.: US 2009/0075528 A1
(43) Pub. Date: Mar. 19, 2009

(54) 90-Degree ferrule and pin terminals

(75) Inventors: Robert H. Osborn, JR., Somerville, TN (US); Michael L. Pratt, Collierville, TN (US)

Correspondence Address: HOFFMANN & BARON, LLP, 6900 JERICHO TURNPIKE, SYOSSET, NY, 11791, US

(73) Assignee: Thomas & Betts International, Inc.

(21) Appl. No.: 12/228,930

(22) Filed: Aug. 18, 2008

Related U.S. Application Data
(60) Provisional application No. 60/994,069, filed on Sep. 17, 2007.

(51) Int. Cl. H01R 13/40; H01R 4/18

(52) U.S. Cl. 439/750; 439/866

(57) ABSTRACT

A ferrule or pin terminal is provided with a bend to facilitate terminations in confined or restricted spaces and provides consistency and uniformity. The ferrule terminal embodiment of the present invention includes a ferrule portion and a barrel portion. The ferrule portion includes a cylindrical wall, a first end, a second end, a longitudinal axis and a stress relief aperture. The ferrule portion is bent along the longitudinal axis to form a bend. The pin terminal embodiment of the present invention includes a solid pin portion and a barrel portion. The solid pin portion includes a body, a first end and a second end and has a longitudinal axis. The first end of the solid pin portion is angularly disposed from the second end. In both embodiments, the barrel portion includes a cylindrical body having a first end adapted to receive an electrical wire and a second end connected to the second end of the ferrule.

This application claims priority from provisional application Ser. No. 60/994,069, filed on Sep. 17, 2007, which is incorporated herein in its entirety.

### FIELD OF THE INVENTION

The present invention relates to connectors for terminating wires. In particular, the present invention relates to 90-degree connectors for terminating wires in a confined space.

### BACKGROUND OF INVENTION

Ferrules and pin terminals are commonly used to ensure reliable electrical connections when terminating stranded control wires in screw clamp-style terminal blocks. The primary benefit of such terminals is that they prevent fraying and breaking of wire strands, which can occur when wires are terminated directly under a terminal block screw clamp. In addition, the terminals can be insulated to provide protection from wire stress due to bending and/or vibration, while facilitating wire insertions into terminal block clamps.

The trend in almost all commercial and industrial products is to reduce the overall size of the products so that they require less space. Accordingly, control panels and enclosures housing electrical components are becoming smaller and are using smaller components so that the space inside is significantly reduced. As a consequence, the space required to insert ferrules or pin terminals straight into a terminal block located inside a control panels or enclosures is often limited.

Ferrules are the preferred alternative to twisting wire strands or tinning the wire end before terminating the wire into a terminal block. Ferrules are thin-walled copper tubes that are made in a variety of sizes to fit different size wires. Typically, the insulation is stripped from the end of a stranded wire and the stripped end is inserted into the insulated end of a ferrule. A crimping tool is used to mechanically crimp the ferrule onto the ends of the stranded wire. The crimped ferrule is then inserted into a terminal block, which is tightened to secure the ferrule and wire in the terminal block.

Pin terminals have a pin on one end and a barrel for receiving a wire on the other end. A stripped wire is inserted into the barrel portion which is crimped to hold the wire in place. The pin end is then inserted into a terminal block. The barrel portion of the pin terminal can be insulated or uninsulated.

The existing designs of ferrule and pin terminals include a straight or linear construction wherein the connected wire is axially aligned with the body of the ferrule or pin terminal. The disadvantage of this construction is that, when there is limited space due to close proximity of other components or obstructions, it is difficult to insert the ferrule or pin terminal into the terminal block. In the past, the solution was to field bend (i.e., the bend is made by the installer) the ferrule or pin terminal so that it fit into the restricted space. However, bending the terminals in this manner can cause them to weaken and eventually break over time, especially when they may be subjected to vibration or movement. The end result is a termination that is often inconsistent and highly unreliable.

Accordingly, there is a need for a ferrule or pin terminal that has a pre-existing 90-degree bend which facilitates the insertion of the terminal into a terminal block in a limited space. Such ferrules or pin terminals would also have a uniform bend.

### SUMMARY OF THE INVENTION

In accordance with the present invention, a ferrule or pin terminal is provided with a bend to facilitate terminations in confined or restricted spaces and provides consistency and uniformity. The ferrule terminal embodiment of the present invention includes a ferrule portion and a barrel portion. The ferrule portion includes a cylindrical wall, a first end, a second end, a longitudinal axis and an aperture. The aperture is located in the cylindrical wall between the first and second ends. The ferrule portion is bent along the longitudinal axis to form a bend. The bend in the longitudinal axis has an angle of from about 15 to about 120 degrees, preferably from about 60 to about 90 degrees. The aperture in the ferrule portion is a stress relief aperture, which preferably has four sides and four rounded corners. The stress relief aperture can also have a substantially round or oval shape.

The barrel portion includes a cylindrical body having a first end adapted to receive an electrical wire and a second end connected to the second end of the ferrule. The ferrule portion has a first diameter and the first end of the barrel portion has a second diameter, which is larger than the first diameter. The barrel portion has a third diameter, which is about equal to the first diameter. The barrel portion can also have a reducing section between the first end and the second end.

The barrel portion also has an exterior surface, which is at least partially covered with an electrically insulating material. The electrically insulating material is preferably a nylon, vinyl or plastic material.

The pin terminal embodiment of the present invention includes: a solid pin portion and a barrel portion. The solid pin portion includes a body, a first end and a second end and has a longitudinal axis. The first end of the solid pin portion is angularly disposed from the second end. The first end is angularly disposed from the second end at an angle of from about 15 to about 120 degrees, preferably at an angle of from about 60 to about 90 degrees. The solid pin portion has a cross-section with a width and a height, wherein the width is greater than the height; preferably the solid pin portion is substantially flat.

The barrel portion includes a cylindrical body having a first end adapted to receive an electrical wire and a second end connected to the second end of the solid pin. The barrel portion can have a reducing section between the first end and the second end. The barrel portion can also include an exterior surface, which is at least partially covered with an electrically insulating material. Preferably, the electrically insulating material is a nylon, vinyl or plastic material.

### BRIEF DESCRIPTION OF THE FIGURES

The preferred embodiments of the ferrule and pin terminals of the present invention, as well as other objects, features and advantages of this invention, will be apparent from the accompanying drawings wherein:

FIG. 1 is a perspective view of an embodiment of a ferrule terminal of the present invention.

FIG. 2 is a perspective view of an embodiment of a pin terminal of the present invention.

FIG. 3 is a perspective view of an embodiment of a ferrule terminal of the present invention.

FIG. 4 is a perspective view of an embodiment of a pin terminal of the present invention.

FIG. 5 is a side view of an embodiment of a ferrule terminal of the present invention.

FIG. 6 is an end view of an embodiment of a ferrule terminal of the present invention.

FIG. 7 is a top view of an embodiment of a ferrule terminal of the present invention.

FIG. 8 is a perspective view of a stranded wire inserted in an embodiment of a ferrule terminal of the present invention.

FIG. 9 is a perspective view of a stranded wire inserted in an embodiment of a pin terminal of the present invention.

### DETAILED DESCRIPTION OF THE INVENTION

The present invention is a terminal that can have a bend of from 10-120 degrees for terminating wires to a terminal block with a ferrule or pin connection. Typically, the ferrule or pin end is connected to the terminal block and the opposing end includes an insulated sleeve for receiving the stripped end of a stranded wire. In applications where space is limited, the bends in the terminals allow them to be installed in terminal blocks from a variety of different angles.

The ferrule terminal can be bent up to about 120 degrees and includes a stress relief aperture to assist in the bending of the thin walled ferrule without creasing or damaging the outer wall. As used herein, the term “ferrule” refers to a cylindrical tube or sleeve made of a conductive metal, such as copper, and having a thin outer wall. The stranded wire is inserted through the insulated sleeve and into the ferrule. The stripped end is pushed through until it extends around the bend in the ferrule and into the second leg (i.e., the open end) of the ferrule, which is bent in relation to the end that is connected to the insulated sleeve. The bend is preferably between about 10 and 120 degrees and most preferably between about 60 and 90 degrees. After the wire is inserted into the ferrule, a standard hand crimp tool is used to crimp the ferrule between the bend and the open end in order to mechanically and electrically connect the wire to the ferrule terminal.

Pin terminals are similar to ferrule terminals, except a solid pin made of an electrically conductive metal is substituted for the ferrule. The pin portion bends near the end where the construction of the pin terminal changes from the insulated barrel portion to the pin portion. The wire is secured in the pin terminal by crimping the insulated terminal end in the same manner as existing designs. Both the ferrule terminal and the pin terminal can have insulated or non-insulated terminal ends. The insulation is typically a nylon, vinyl or plastic material.

The ferrule terminal has a bend relief aperture that facilitates bending the thin walled copper ferrule. The edge of the bend relief aperture around the perimeter has a generally rounded configuration to reduce the stress on at any single point when the ferrule terminal is bent. The bend relief aperture is preferably formed in the ferrule terminal by a stamping process before the metal stamping is rolled into the cylindrical shape of the ferrule terminal. The bend relief aperture can have a generally rectangular shape with rounded corners that spread the stresses when the ferule terminal is bent to prevent the walls of the ferrule terminal from creasing and or splitting. The bend relief aperture can also have a generally round or oval shape that spreads any stresses from the bending process over a greater area. The ferrule terminal can also be made from a tubular material with the bend relief aperture formed in the cylindrical body of the ferrule terminal by a cutting or grinding process. One skilled in the art will appreciate that there are many ways to form the bend relief aperture in the ferrule terminal. The important feature of the present invention is that the corners of the bend relief aperture are rounded to distribute the stress that occurs when the ferrule terminal is bent.

The stripped end of a wire is inserted into the ferrule terminal from the insulator side and follows the bend of the ferrule into the leg of the ferrule that is bent at an angle of up to 120 degrees, preferably an angle of between 60 and 90 degrees. Preferably, the leg of the ferrule that is bent up 90 degrees is the portion that is crimped. However, the leg of the ferrule next to the barrel portion or both legs of the ferrule can be crimped. A pliers or standard hand crimp tools are used to crimp the ferrule.

In one embodiment of the present invention, the pin terminal has a longer straight pin portion, which can be bent to create angles of up to 120 degrees with respect to the barrel portion. The entire pin or a portion of the pin where the bend is formed is made of a malleable metal that does not fracture when bent.

In another embodiment for a ferrule terminal, a ferrule bent at an angle of up to 120 degrees fits over an existing ferrule terminal that has a straight construction. The bent ferrule has two legs that are angularly disposed to each other. The first leg fits over the ferrule portion of a straight ferrule terminal and the second leg is inserted into a terminal block. The bent ferrule converts the straight ferrule terminal into a bent configuration and allows it to be terminated in a terminal block from a plurality of different angles. The first leg of the bent ferrule fits over the ferrule portion of a straight ferrule. After the stripped wire end is inserted into the straight ferrule terminal and the bent ferrule, the bent ferrule and the straight ferrule are simultaneously crimped to mechanically and electrically connect the wire and the ferrule.

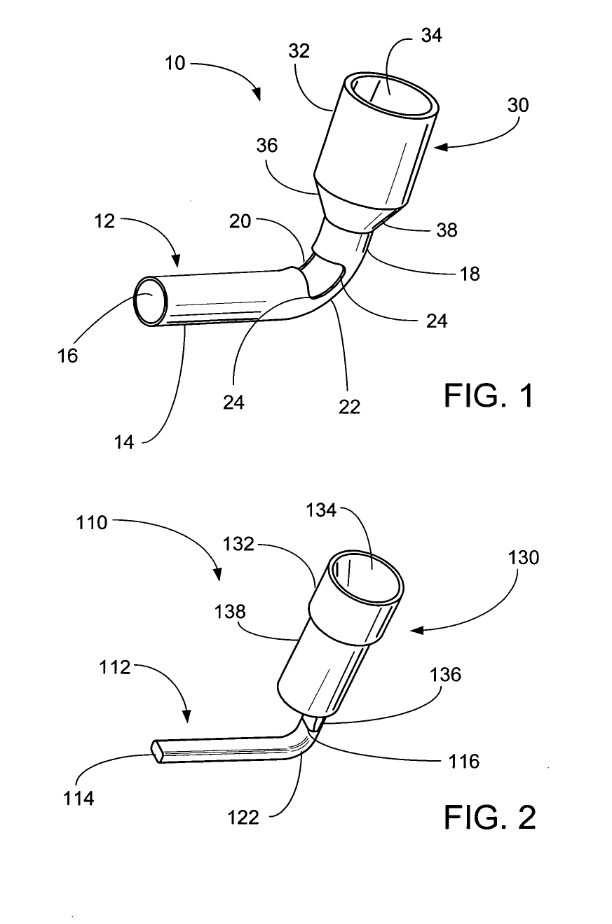

Referring now to the drawings, FIGS. 1 and 3 show a ferrule terminal 10 that includes a ferrule portion 12 and a barrel portion 30. The ferrule portion 12 includes a cylindrically shaped outer wall 14, a first end 16, a second end 18 and a stress relief aperture 20 in the wall 14 near the second end 18. The ferrule portion 12 is bent with the stress relief aperture 20 located at the inner radius of the bend to facilitate bending and to prevent the outer wall 14 from creasing when the bend is formed.

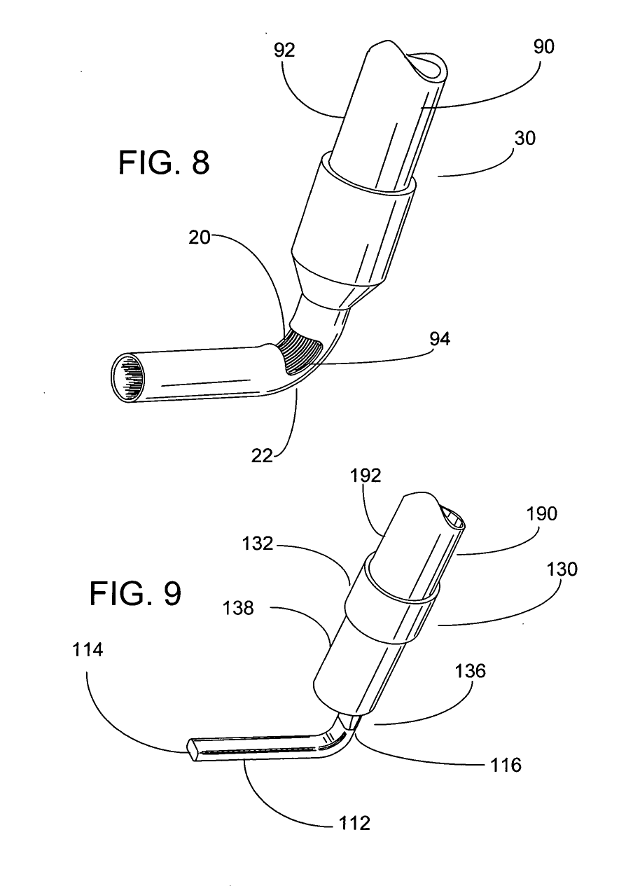

The barrel portion 30 has a hollow cylindrical body 32 with a first end 34 and a second end 36. The second end 36 is connected to the second end 18 of the ferrule portion 12 so that the first end 34 of the barrel portion 30 is in communication with the interior of the ferrule portion 12. The diameter of the first end 34 is selected so that an insulated wire (see FIG. 8) can be inserted into the barrel portion 30. The ferrule portion 12 has a smaller diameter since it is designed to receive the stripped end 94 of the wire 90 (see FIG. 8). Accordingly, FIG. 1 shows a reducing section 38 of the barrel portion 30 near the second end 36, which decreases the diameter of the barrel portion 30 so that it is substantially the same as the second end 18 of the ferrule portion 12.

FIG. 3 shows the terminal end 30 formed from an insulating material such as a nylon, vinyl or plastic. After the end 94 of the wire 90 (FIG. 8) is stripped for insertion into the barrel portion 30, the insulation protects the stripped wire 94 so that it cannot contact other wires or terminals. FIG. 3 also shows how the stress relief aperture 20 has rounded corners 24 (see FIG. 1), which distributes the forces on the corners 24 of the aperture 20 over a larger area and prevents the outer wall 14 from splitting. The stress relief aperture 20 facilitates the formation of the bend 22 and prevents a crease from forming on the inside radius of the bend 22.

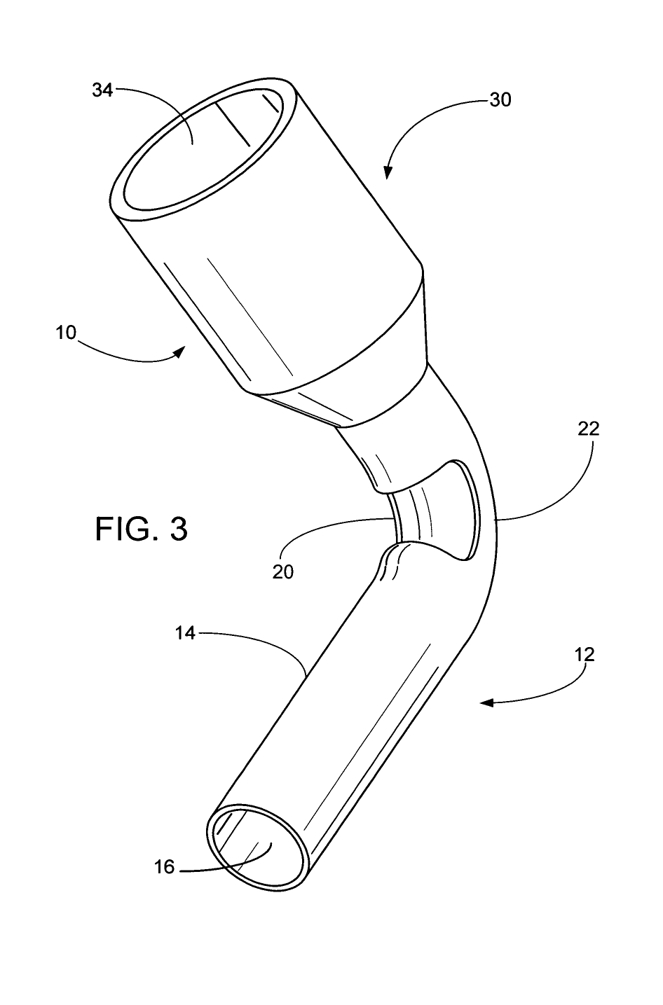

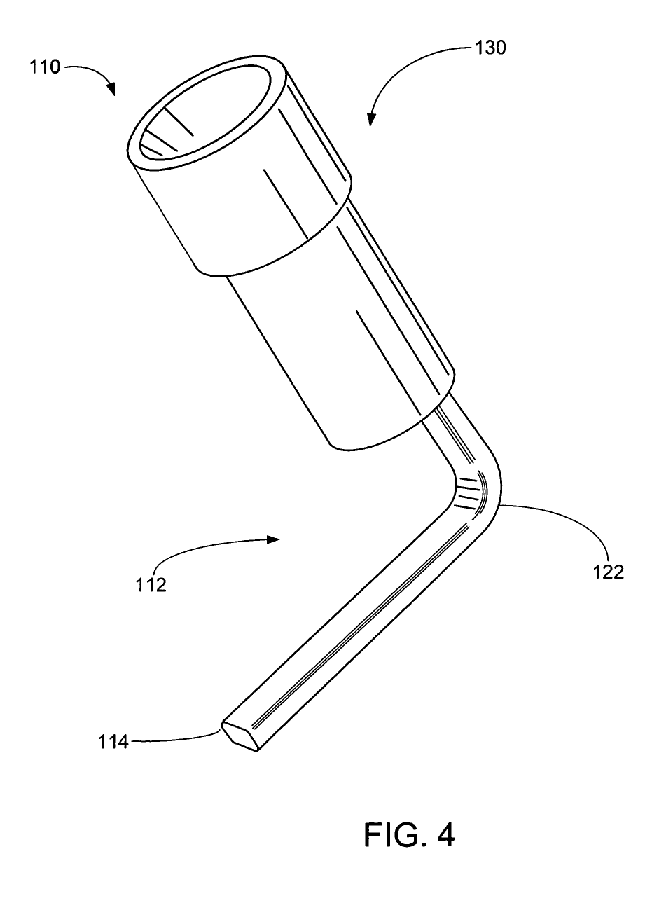

FIGS. 2 and 4 show a pin terminal 110 having a pin portion 112 and a barrel portion 130. The pin portion 112 has a first end 114, a second end 116 and a bend 122 of about 90 degrees near the second end 116. The barrel portion 130 has a hollow, cylindrical body with first and second sections 132, 138 and an open first end 134 and a closed second end 136. The diameter of the first section 132, which receives an insulated wire 190 (see FIG. 9), is greater than the diameter of the second section 138, which receives the stripped end of the wire 190. The closed second end 136 is electrically and mechanically connected to the second end 116 of the pin portion 112.

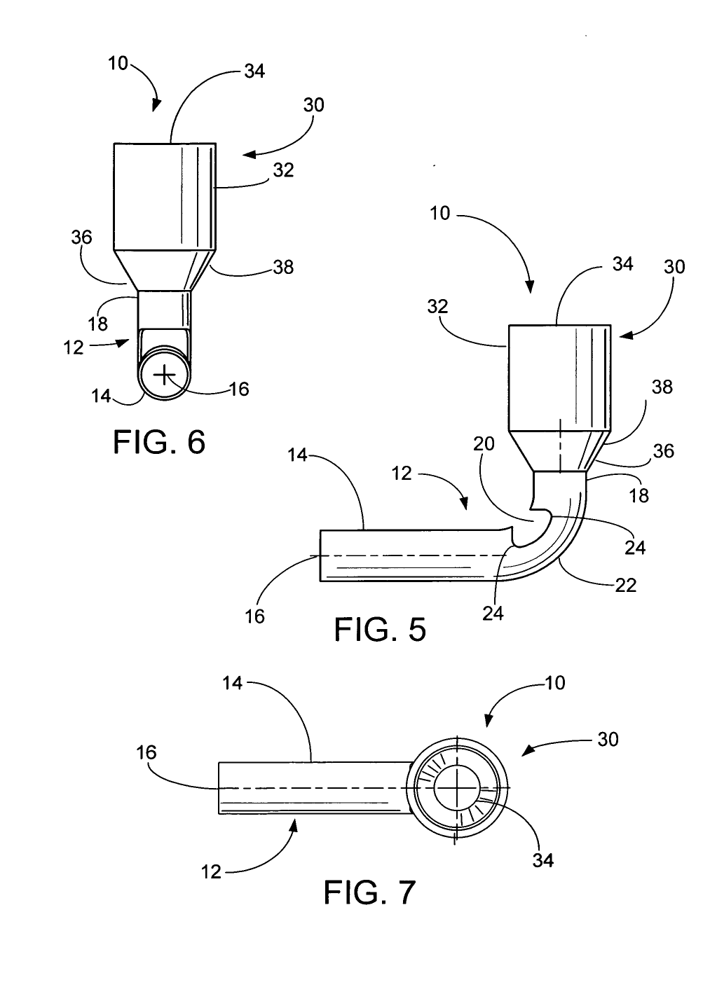

FIGS. 5-7 show a ferrule terminal 10 similar to the ferrule terminals 10 in FIGS. 1 and 3 from a side view (FIG. 5), an end view (FIG. 6) and a top view (FIG. 7). FIG. 5 illustrates how the curved corners 24 of the stress relief aperture 20 evenly distribute the force around the perimeter of the aperture 20 to minimize stress. FIGS. 6 and 7 show how a continuous passage is formed between the first end 16 of the ferrule portion 12 and the first end 34 of the barrel portion 30. FIG. 6 also illustrates the thin outer wall 14 of the ferrule portion 12 that allows it to be easily crimped after a stranded wire 90 is inserted (see FIG. 8).

FIG. 8 shows a stranded wire 90 inserted into an embodiment of the ferrule terminal 10 with a bend 22 of about 90 degrees. The end of the wire 90 is stripped to uncover a plurality of wire strands 94 under an insulted cover 92. When the wire 90 is inserted into the barrel portion 30, the insulated cover 92 extends into the barrel portion 30 and the stripped wire strands 94 extend into the ferrule portion 12. The ferrule portion 12 is then crimped at a point midway between the aperture 20 and the first end 16 to mechanically and electrically contact the wire strands 94 and secure the wire 90 in the ferrule terminal 10.

The stripped end of a wire 190 (FIG. 9) is inserted into the first end 134 of the barrel portion 130 and passes through the first section 132 and into the second section 138. The insulated cover 192 of the wire 190 above the stripped end fits into the first section 132 of the barrel portion 130. The second section 138 is crimped to mechanically and electrically contact the wire strands (not shown) and secure the wire 190 in the barrel portion 130.

Thus, while there have been described the preferred embodiments of the present invention, those skilled in the art will realize that other embodiments can be made without departing from the spirit of the invention, and it is intended to include all such further modifications and changes as come within the true scope of the claims set forth herein.

We claim:

1. A ferrule terminal comprising:
a ferrule portion comprising a cylindrical wall, a first end, a second end, a longitudinal axis and an aperture, wherein the aperture is located in the cylindrical wall between the first and second ends, and wherein the ferrule portion is bent along the longitudinal axis to form a bend; and
a barrel portion comprising a cylindrical body having a first end adapted to receive an electrical wire and a second end connected to the second end of the ferrule.

2. The ferrule terminal according to claim 1, wherein the bend in the longitudinal axis has an angle of from about 15 to about 120 degrees.

3. The ferrule terminal according to claim 1, wherein the bend in the longitudinal axis has an angle of from about 60 to about 90 degrees.

4. The ferrule terminal according to claim 1, wherein the ferrule portion has a first diameter and the first end of the barrel portion has a second diameter, and wherein the second diameter is larger than the first diameter.

5. The ferrule terminal according to claim 4, wherein the second end of the barrel portion has a third diameter, and wherein the first diameter and the third diameter are about equal.

6. The ferrule terminal according to claim 5, wherein barrel portion has a reducing section between the first end and the second end.

7. The ferrule terminal according to claim 1, wherein the aperture is a stress relief aperture with a substantially round or oval shape.

8. The ferrule terminal according to claim 1, wherein the aperture is a stress relief aperture having four sides and four rounded corners.

9. The ferrule terminal according to claim 1, wherein the barrel portion further comprises an exterior surface, and wherein the exterior surface is at least partially covered with an electrically insulating material.

10. The ferrule terminal according to claim 1, wherein the electrically insulating material is a nylon, vinyl or plastic material.

11. A pin terminal comprising:
a solid pin portion comprising a body, a first end and a second end, wherein the solid pin portion has a longitudinal axis, and wherein the first end is angularly disposed from the second end; and
a barrel portion comprising a cylindrical body having a first end adapted to receive an electrical wire and a second end connected to the second end of the solid pin.

12. The pin terminal according to claim 11, wherein the first end is angularly disposed from the second end at an angle of from about 15 to about 120 degrees.

13. The pin terminal according to claim 11, wherein the first end is angularly disposed from the second end at an angle of from about 60 to about 90 degrees.

14. The pin terminal according to claim 11, wherein the solid pin portion has a cross-section with a width and a height, and wherein the width is greater than the height.

15. The pin terminal according to claim 14, wherein the solid pin portion is substantially flat.

16. The pin terminal according to claim 15, wherein barrel portion has a reducing section between the first end and the second end.

17. The pin terminal according to claim 11, wherein the barrel portion further comprises an exterior surface, and wherein the exterior surface is at least partially covered with an electrically insulating material.

18. The pin terminal according to claim 11, wherein the electrically insulating material is a nylon, vinyl or plastic material.

19. A ferrule terminal comprising:
a ferrule portion comprising a cylindrical wall, a first end, a second end, a longitudinal axis and a stress relief aperture having a substantially round or oval shape or having four sides and four rounded corners, wherein the aperture is located in the cylindrical wall between the first and second ends, and wherein the ferrule portion is bent along the longitudinal axis to form a bend; and
a barrel portion comprising a cylindrical body having a first end adapted to receive an electrical wire, a second end connected to the second end of the ferrule and a reducing section between the first end and the second end.

20. The ferrule terminal according to claim 1, wherein the barrel portion further comprises an exterior surface, and wherein the exterior surface is at least partially covered with a nylon, vinyl or plastic electrically insulating material.
